(19) United States
(12) Patent Application Publication
(10) Pub. No.: US 2006/0167740 A1
(43) Pub. Date: Jul. 27, 2006

(54) System and method for processing objectives

(76) Inventors: Scott M. Consolatti, Raleigh, NC (US); Tong L. Li, Cary, NC (US); Glen E. Salmon, Amesbury, MA (US)

Correspondence Address: HOFFMAN, WARNICK & D'ALESSANDRO LLC, 75 STATE ST, 14TH FLOOR, ALBANY, NY, 12207, US

(21) Appl. No.: 11/040,041

(22) Filed: Jan. 21, 2005

(51) Int. Cl. G06F 9/44; G06F 17/30; G07G 1/00

(52) U.S. Cl. 705/10; 705/7

(57) ABSTRACT

A method, system, and computer program product for processing objectives of an organization. Included is a computerized system having: an objective creation system for defining new objectives and setting associated target values for a defined time period; an objective linking system for linking a set of source objectives to a destination objective; and an objective analysis system for comparing a current actual value with a current target value for a selected objective.

### BACKGROUND OF THE INVENTION

1. Field of the Invention

The present invention relates generally to a computer implemented system for processing business objectives, and more specifically, the present invention provides a method, system, and computer program product for defining, linking, and tracking organizational wide objectives.

2. Background Art

In order to track the success or failure of an organization, objectives are typically defined by the organization for some time period. For instance, an objective for a business might be $100 million in sales of a particular product for the upcoming year. Sales performance can then be compared to the objective to measure success or failure. Such objectives are defined based on goals required to implement a desired strategy for the organization.

Objectives are typically broken down into finer and finer detail down through the organization. For example, product sales for the aforementioned business may be organized by region, district, territory and individual salesperson. Thus, the business may have four regions, each having a sales objective of $25 million. One of those regions may have five districts, each with an objective of $5 million in sales. Each district in a given region may be responsible for $1 million, with territories having objectives of $200,000. Finally, individual sales people in the territories may have goals of $100,000 each.

Unfortunately, the impact of a lower level objective on one higher up in the organization is not automatically evident, and the impact is often detected too late to properly address the problem. Instead, each level in an organization typically evaluates its own progress and success based on external data and human effort. For instance, in the above example, a region will determine whether it is meeting its objectives by collecting and adding sales performance figures from each of its districts. If one of the districts is not meeting its objectives, additional human effort is typically required to determine which territory or territories are contributing to the failure, and which sales people within a given territory are failing to meet their objectives.

The ability to analyze objectives across an entire organization in an automated fashion would allow management at different levels to study and understand the performance of the organization. Unfortunately, there currently exists no automated mechanism that supports organization-wide objectives, the linking of objectives, and the impact or contribution a lower level objective has on a higher level objective.

### SUMMARY OF THE INVENTION

In general, the present invention provides a method, system, and computer program product that allows an organization's objectives to be entered and tracked for any number of organizational levels. The invention further allows for the linking of objectives both through a reporting hierarchy, as well as across matrixed teams, in which the linkages define dependencies and contributions one objective makes on another.

In a first aspect, the invention provides a computerized system for processing objectives, comprising: an objective creation system for defining new objectives and setting associated target values for a defined time period; an objective linking system for linking a set of source objectives to a destination objective; and an objective analysis system for comparing a current actual value with a current target value for a selected objective.

In a second aspect, the invention provides a program product stored on a computer readable medium for processing objectives, comprising: program code configured for defining new objectives and setting associated target values for a defined time period; program code configured for linking a set of source objectives to a destination objective; and program code configured for comparing a current actual value with a current target value for a selected objective.

In a third aspect, the invention provides a computerized method for processing objectives, comprising: defining new objectives and setting associated target values for a defined time period; linking a set of source objectives to a destination objective; and comparing a current actual value with a current target value for a selected objective.

In a fourth aspect, the invention provides a method for deploying an application for processing objectives, comprising: providing a computer infrastructure being operable to: define new objectives and setting associated target values for a defined time period; link a set of source objectives to a destination objective; and compare a current actual value with a current target value for a selected objective.

In a fifth aspect, the invention provides computer software embodied in a propagated signal for processing objectives, the computer software comprising instructions to cause a computer system to perform the following functions: defining new objectives and setting associated target values for a defined time period; linking a set of source objectives to a destination objective; and comparing a current actual value with a current target value for a selected objective.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having an objective processing system in accordance with the present invention.

FIG. 2 depicts an interface for an objective creation system in accordance with the present invention.

FIG. 3 depicts an interface for an objective linking system in accordance with the present invention.

FIG. 4 depicts an interface for an objective analysis system in accordance with the present invention.

### DETAILED DESCRIPTION OF THE INVENTION

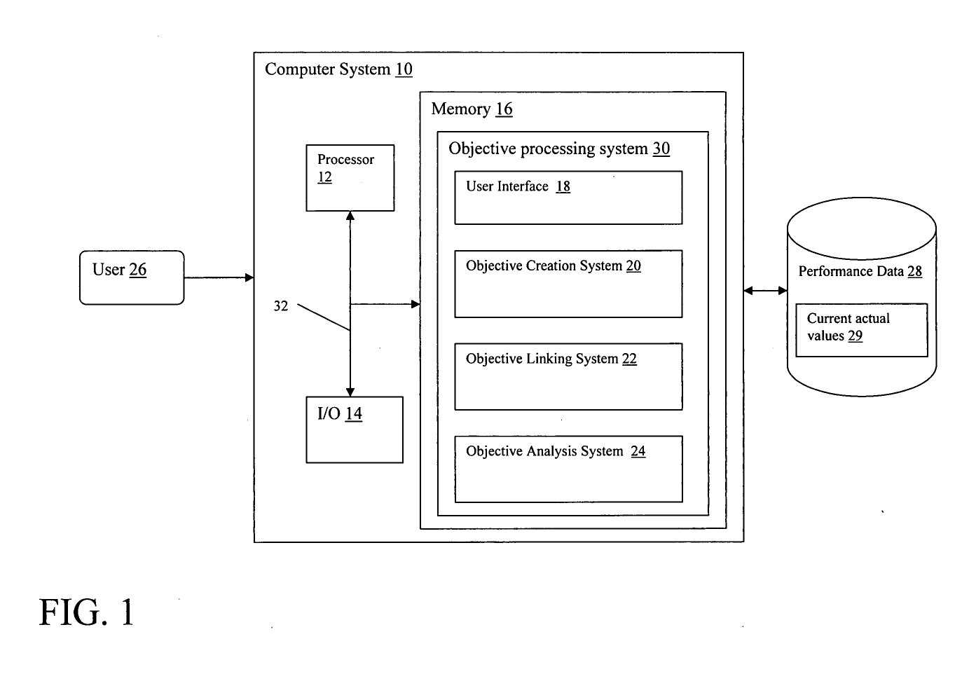

Referring now to the figures, FIG. 1 depicts a computer system 10 having an objective processing system 30 for defining, linking, and analyzing organizational wide objectives. Computer system 10 is intended to represent any type of computerized system capable of implementing the methods and features of the present invention. For example, computer system 10 may comprise a desktop computer, laptop, workstation, server, PDA, cellular phone, pager, etc. As shown, computer system 10 generally includes a processor 12, memory 16, bus 32, and input/output interfaces (I/O) 14. Processor 12 may comprise a single processing unit, or may be distributed across one or more processing units in one or more locations, e.g., on a client and server. Memory 16 may comprise any known type of data storage and/or transmission media, including magnetic media, optical media, random access memory (RAM), read-only memory (ROM), etc. Moreover, similar to processor 12, memory 16 may reside at a single physical location, comprising one or more types of data storage, or be distributed across a plurality of physical systems in various forms.

I/O 14 may comprise any system for exchanging information to and from external devices/resources (not shown). External devices/resources may comprise any known type of external device, including: storage, a display, handheld device, keyboard, mouse, voice recognition system, speech output system, printer, facsimile, pager, speakers etc.

Bus 32 provides a communication link between each of the components in computer system 10, and likewise may comprise any known type of transmission link, including electrical, optical, wireless, etc. In addition, although not shown, additional components, such as cache memory, communication systems, system software, etc., may be incorporated into computer system 10.

Shown in memory 16 is objective processing system 30, which includes a user interface 18, an objective creation system 20, an objective linking system 22, and an objective analysis system 24. An objective may be generally defined as any type of quantifiable goal or metric set by an organization. Common examples may include sales figures, production, reported errors, product failures, inventory, etc. User interface 18 allows a user 26 to access the features of objective processing system 30 as described in further detail below.

In general, objective creation system 20 provides a mechanism through which user 26 can define an objective for a particular organizational level. For instance, an objective of $100 million in annual sales may be set for a regional unit of an organization. Objective linking system 22 is utilized to link objectives from different levels in the organization. For instance, the above-mentioned regional unit may be divided into several territories, each having a defined objective that makes up a part of the $100 million regional sales objective. Objective analysis system 24 allows user 26 to view an analysis of current performance data 28 relative to one or more defined objectives. For instance, at a given point through the year, the current actual value of regional sales may total $65 million, which may be ahead of, behind, or on target relative to the defined objective. Accordingly, performance data 28 is made up of “current actual values” 29 captured or calculated by objective processing system 30.

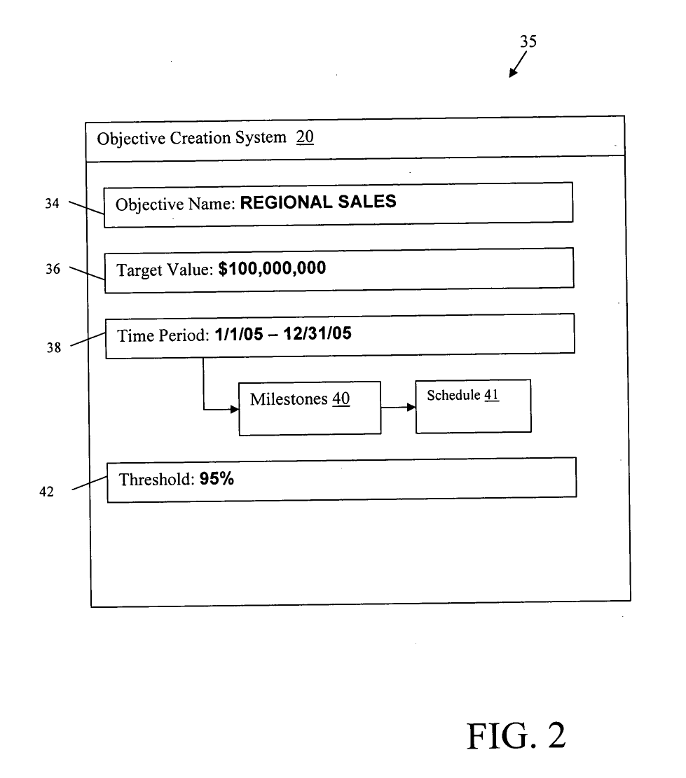

FIG. 2 depicts an illustrative interface 35 for accessing objective creation system 20. Interface 35 allows the user 26 to enter an objective name (and/or description) 34, a target value 36, a time period 38, and a threshold 42. The target value 36 is a value that represents success for the objective and may include, e.g., a number, percentage, dollar amount, Boolean value, etc. Time period 38 represents a start and end time for the objective in which the target value 36 should be reached. In addition to specifying a time period 38 and target value 36, the user 26 may also define milestones 40 that provide intermittent target values to be reached during the time period 38. For instance, milestones 40 may be set up for each month during the year. The milestones 40 can be utilized to generate a schedule 41 (e.g., a function, a curve, etc.), which allows a “current target value” to be determined at any point along the objective's time period 38 (e.g., by interpolating or curve fitting the milestones). The current target value allows for ongoing analysis of the objective. A threshold 42 may also be set, which is used to calculate a percentage of the current target value to determine whether the objective is at risk of not being achieved. In the example shown, the objective name “REGIONAL SALES” has been created having a target value of $100 million for the time period Jan. 1, 2005-Dec. 31, 2005, and a threshold of 95%. It should be understood that the depicted interface 35 is shown for illustrative purposes only, and that variations to the interface could be implemented without departing from the scope of the invention.

Once a set of objectives are created, two or more of the objectives can be linked together by user 26. Objectives are either leaf nodes or aggregates. Leaf node objectives get their performance data 28 from direct user input or an external data source. Aggregate objectives get their performance data 28 by aggregating performance data 28 of lower level objectives using a defined formula.

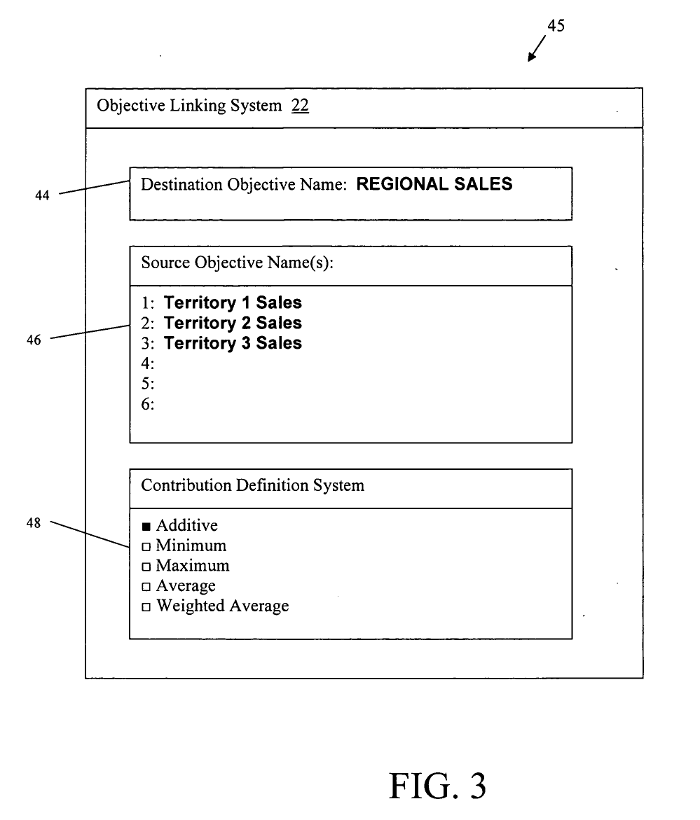

FIG. 3 depicts an illustrative interface 45 showing objective linking system 22. Linking allows a contribution (or aggregation) of one or more objectives (i.e., source objectives) to impact a higher level objective (i.e., a destination objective). For instance, as shown in FIG. 3, “REGIONAL SALES” has been entered as a destination objective in the destination objective name window 44, and “Territory 1 Sales,” “Territory 2 Sales,” and “Territory 3 Sales” have been entered as source objectives in the linked objective name(s) window 46. Thus, the performance data 28 for each of “Territory 1 Sales,” “Territory 2 Sales,” and “Territory 3 Sales” will contribute to the performance data 28 of REGIONAL SALES. Moreover, a destination objective may be a source objective for a higher level in the organization (e.g., DIVISION SALES), and a source objective may be a destination objective for a lower level in the organization (e.g., a salesperson).

Contribution Definition System window 48 allows the user to select a contribution formula that defines how the source objectives impacts the destination objective. The mathematical contribution of a source objective on a destination objective is determined by selecting or defining such a contribution formula. In the example of FIG. 3, the user 26 is able to select from five predefined formulas: additive, minimum, maximum, average, and weighted average. If additive is selected, the current actual values of all source objectives are added together and the result is assigned as the current actual value of for the destination objective. If minimum is selected, the smallest of the current actual values of all source objectives is selected as the current actual value of the destination objective. If maximum is selected, the largest of the current actual values of all source objectives is selected as the current actual value of the destination objective. If average is selected, the current actual values of each of the source objectives are averaged together and the result is assigned as the current actual value of the destination objective. If weighted average is selected, the current actual values of all source objectives are multiplied by their respective weighting, which are then added together and the result is assigned as the current actual value of the destination objective. It should be understood the contributions described herein are not an exhaustive list, and other contribution definitions may be used without departing from the scope of the invention.

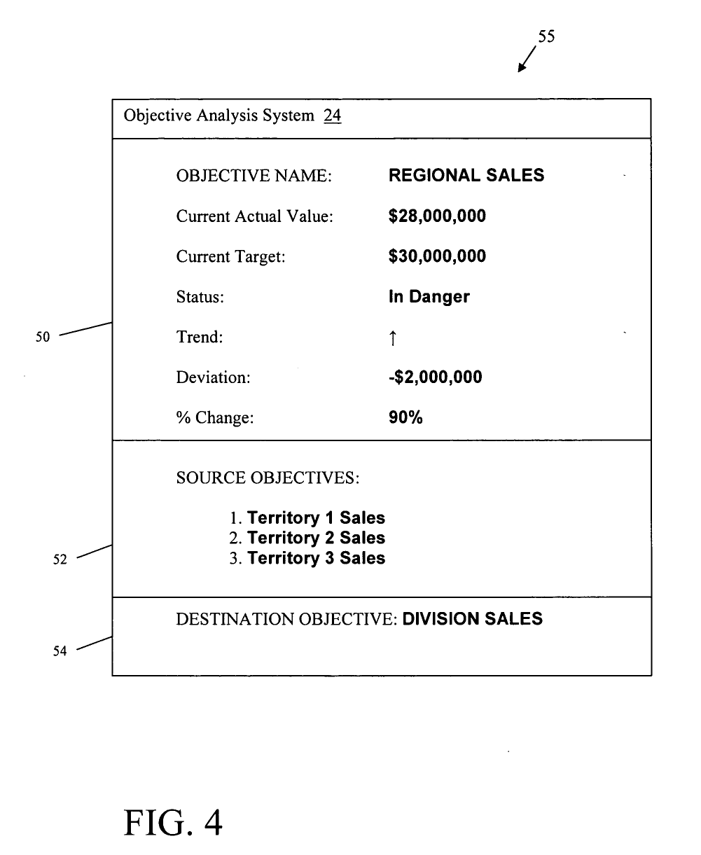

Referring now to FIG. 4, an illustrative interface 55 is shown depicting objective analysis system 24. Interface 55 provides an “objective performance” window 50 for the user 26 to view and analyze a selected objective, a “source objectives” window 52 that lists all the source objectives that contribute to the selected objective, and a “destination objective” window 54 that lists a destination objective, if any, of the selected objective. In an illustrative embodiment, the user 26 can navigate up and down along a linked hierarchy of objectives by clicking on a source or destination objective, which will take the user down or up a level in the organization. Thus, by clicking on Territory 1 Sales, the user 26 would be able to view the lower level objective performance of Territory 1 Sales in a similar interface as that shown in FIG. 4. By clicking on DIVISION SALES, the user 26 would be able to view the higher level objective performance of DIVISION SALES.

The objective analysis system 24 stores and computes information for each of the defined objectives, including: (1) a current actual value, which is the most recent measurement of performance or progress for an objective, either individually captured or computed through aggregation; (2) current target, which as described above is the defined target value of the objective prorated by the schedule 41 for the current point in time; (3) current status, which is an indicator of how successfully the objective is being reached, based on the current actual value, the current target, and the objective's defined threshold; (4) trend, which is an indicator of how the execution of the objective has changed over time; (5) deviation, which is the delta of the current actual value to the current target; and (6) % change, which is the percent change of the current deviation to a previously calculated deviation.

As shown in the example of FIG. 4, the objective “REGIONAL SALES” has been selected for display by the user 26. In the example, the current actual value, i.e., regional sales to date, is shown at $28 million, with the current target being $30 million. The current status is determined by comparing the current actual value to the product of the current target multiplied by the threshold. If the current actual value is above the product, then the status may be listed as “On Target,” and if the current actual value is below the product, then the status may be listed as “In Danger.” In the example shown, because the threshold was set at 95% for the objective, the status is listed as “In Danger” since $28 million is less than 95% of $30 million (i.e., 0.95×$30 million=$28.5 million). In this example, the trend is shown as upward, meaning that the execution of the objective is improving (based on a comparison with previous data). The deviation is −$2 million (i.e., $28 million−$30 million), and the percent change is 90%, meaning that the deviation is 0.9 times what is previous was.

Obviously, the interfaces shown in FIG. 2-4 are provided for illustrative purposes only, and the specific types of data and format used therein could vary without departing from the scope of the invention.

It should be appreciated that the teachings of the present invention could be offered as a business method on a subscription or fee basis. For example, computer system 10 could be created, maintained, supported, and/or deployed by a service provider that offers the functions described herein for customers. That is, a service provider could be used to process organizational objectives over a network. It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computerized system for processing objectives, comprising:
an objective creation system for defining new objectives and setting associated target values for a defined time period;
an objective linking system for linking a set of source objectives to a destination objective; and
an objective analysis system for comparing a current actual value with a current target value for a selected objective.

2. The computerized system of claim 1, wherein the objective creation system includes a first interface for entering a target value and a date range to achieve the target value.

3. The computerized system of claim 2, wherein the objective creation system further allows a set of milestones comprised of intermittent target values to be defined during the date range.

4. The computerized system of claim 2, wherein the first interface further allows for an entering of a threshold value.

5. The computerized system of claim 1, wherein the object linking system includes a second interface for identifying the set of source objectives and destination objective.

6. The computerized system of claim 1, wherein the set of source objectives contribute to the destination objective based on a contribution formula.

7. The computerized system of claim 6, wherein the contribution formula is selected from the group consisting of: additive, minimum, maximum, average, and weighted average.

8. The computerized system of claim 1, wherein the current target value is calculated as a function of the set target value for an objective at a point in time during the defined time period.

9. The computerized system of claim 1, wherein the objective analysis system includes a third interface for displaying the current actual value and current target value for a selected objective.

10. The computerized system of claim 9, wherein the third interface further displays analysis information selected from the group consisting of: a status, a trend, a deviation and a percent change in deviation.

11. The computerized system of claim 9, wherein the objective analysis system further includes a system for navigating amongst linked objectives.

12. A program product stored on a computer readable medium for processing objectives, comprising:
program code configured for defining new objectives and setting associated target values for a defined time period;
program code configured for linking a set of source objectives to a destination objective; and
program code configured for comparing a current actual value with a current target value for a selected objective.

13. The program product of claim 12, further comprising a first interface for entering a target value and a date range to achieve the target value.

14. The program product of claim 13, wherein the first interface further allows a set of milestones comprised of intermittent target values to be defined during the date range.

15. The program product of claim 13, wherein the first interface further allows for an entering of a threshold value.

16. The program product of claim 12, further comprising a second interface for identifying the set of source objectives and destination objective.

17. The program product of claim 12, wherein the set of source objectives contribute to the destination objective based on a contribution formula.

18. The program product of claim 17, wherein the contribution formula is selected from the group consisting of: additive, minimum, maximum, average, and weighted average.

19. The program product of claim 12, wherein the current target value is calculated as a function of the set target value for an objective at a point in time during the defined time period.

20. The program product of claim 12, further comprising a third interface for displaying the current actual value and current target value for a selected objective.

21. The program product of claim 20, wherein the third interface further displays analysis information selected from the group consisting of: a status, a trend, a deviation and a percent change in deviation.

22. The program product of claim 20, wherein the third interface further includes a system for navigating amongst linked objectives.

23. A computerized method for processing objectives, comprising:
defining new objectives and setting associated target values for a defined time period;
linking a set of source objectives to a destination objective; and
comparing a current actual value with a current target value for a selected objective.

24. The computerized method of claim 23, wherein the defining step includes the steps of entering a target value and a date range to achieve the target value.

25. The computerized method of claim 24, wherein the defining step further allows a set of milestones comprised of intermittent target values to be defined during the date range.

26. The computerized method of claim 24, wherein the defining step further allows for an entering of a threshold value.

27. The computerized method of claim 23, wherein the linking step includes the step of identifying the set of source objectives and destination objective.

28. The computerized method of claim 23, wherein the set of source objectives contribute to the destination objective based on a contribution formula.

29. The computerized method of claim 28, wherein the contribution formula is selected from the group consisting of: additive, minimum, maximum, average, and weighted average.

30. The computerized method of claim 23, wherein the current target value is calculated as a function of the set target value for an objective at a point in time during the defined time period.

31. The computerized method of claim 23, wherein the analysis step includes the step of displaying the current actual value and current target value for a selected objective.

32. The computerized method of claim 31, wherein the analysis step displays analysis information selected from the group consisting of: a status, a trend, a deviation and a percent change in deviation.

33. The computerized method of claim 31, comprising the further step of navigating amongst linked objectives.

34. A method for deploying an application for processing objectives, comprising:
providing a computer infrastructure being operable to:
define new objectives and setting associated target values for a defined time period;
link a set of source objectives to a destination objective; and
compare a current actual value with a current target value for a selected objective.

35. Computer software embodied in a propagated signal for processing objectives, the computer software comprising instructions to cause a computer system to perform the following functions:
defining new objectives and setting associated target values for a defined time period;
linking a set of source objectives to a destination objective; and
comparing a current actual value with a current target value for a selected objective.
